(19) United States
(12) Patent Application Publication
(10) Pub. No.: US 2004/0154335 A1
(43) Pub. Date: Aug. 12, 2004

(54) Method and apparatus for producing glass bodies

(75) Inventors: Othmar Hayoz, Urdorf (CH); Van Xeng Lai, Zurich (CH); David Merino, Zurich (CH); Thomas Allenspach, Besenburen (CH)

Correspondence Address: BURNS DOANE SWECKER & MATHIS L L P, POST OFFICE BOX 1404, ALEXANDRIA, VA, 22313-1404, US

(73) Assignee: Mettler-Toledo GmbH

(21) Appl. No.: 10/771,448

(22) Filed: Feb. 5, 2004

(30) Foreign Application Priority Data
Feb. 6, 2003 (EP) 03100253.8

(51) Int. Cl. C03B 9/40

(52) U.S. Cl. 65/29.11; 65/29.17; 65/29.15; 65/29.18; 65/158; 65/161; 65/164; 65/125; 65/301

(57) ABSTRACT

Production of a glass body provided with a glass membrane is disclosed, for a chemical sensor, in which a displaceably mounted dip tube through which a gaseous medium can flow is dipped into a mass of molten glass and pulled out again to withdraw a gob which is then put into the desired shape by supply of the gaseous medium. The dip tube is inserted into a mount, which is connected to a displaceably supported carriage which is then displaced as far as a lower end position (P1), which is defined on the basis of an adjustment device such that when the carriage moves downward the dip tube dips into the molten glass, and upon the retraction of the carriage the dip tube withdraws a gob that is suitable for processing. After one or more withdrawals of a gob, the one-piece or multiple-piece adjustment device is readjusted manually or automatically by a certain amount, to compensate for changes in the level of the molten glass caused by the withdrawal of gobs.

### CROSS REFERENCE TO RELATED APPLICATIONS

This application claims priority under 35 U.S.C. §119 to European Application 03100253.8 filed in Europe on Feb. 6, 2003, the entire contents of which are hereby incorporated by reference in their entireties.

### BACKGROUND

A method and an apparatus for producing glass bodies are disclosed.

Glass bodies for chemical sensors, in particular pH electrodes, are described for instance in the following product sheets of Mettler-Toledo GmbH, CH-8902 Urdorf, Switzerland: [1] “Low- Maintenance pH Electrodes and Systems”, September 2002; [2] “InPro 2000 pH-Elektrode mit Flüssigelektrolyt und integriertem Temperaturfühler” [InPro 2000 pH Electrodes with Liquid Electrolyte and Integrated Temperature Sensor], October 2000; or [3] “InPro 3200 (SG) pH-Elektrode mit Gelelektrolyt und integriertem Temperaturfühler” [InPro 3200 pH Electrodes with Gel Electrolyte and Integrated Temperature Sensor], January 2002.

The basic structure of exemplary pH electrodes, which as combination electrodes include a glass electrode and a reference electrode, is shown in references [2] and [3] as well as below in FIG. 7. In the combination electrode, the glass electrode, provided with a lead-off element 281, and the reference electrode, provided with a reference lead-off element 282, are structurally combined. The glass electrode is surrounded annularly by the reference electrode. The mode of operation of these pH electrodes is described in [4] Charles E. Mortimer, Chemie, Das Basiswissen der Chemie [Chemistry: Basic Chemistry], Fifth Edition, Georg Thieme Verlag, New York, 1997, pp. 337-338 in connection with the test equipment shown in FIG. 20.9.

In a first chamber 291 inside an inner tube 21 and a thin-walled glass hemisphere, or glass membrane 25 respectively, attached to it, the lead-off element 281, which normally comprises silver/silver chloride, is dipped into a solution of a defined pH value, or inner buffer 271 (for buffer solutions, see reference [4], page 282), which represents the conductive connection between the inside of the glass membrane 25 and the lead-off element 281.

The semipermeable glass membrane 25 is pH-sensitive. At it, a potential is formed that is a direct measure for the pH value of the tested solution or of the product being measured. As soon as the pH electrode dips into the product being measured, the glass membrane 25 begins to swell on the outside; that is, Na+ is replaced by H+. The inner side is constantly swollen, since it is always wetted by the inner buffer 271. Typically, the pH value of the inner buffer is set at a pH-Value of 7 (neutral). The hydrogen ions in the solution or the ions of the inner buffer can diffuse into these swelling layers, which have a thickness of <0.0001 mm. If the pH electrode dips into the product being measured, which has exactly as many protons as the inner buffer 271, then the difference in the charges between the inner buffer 271 and the product being measured ideally equals 0. This means that no potential is built up at the pH-electrode. From this it can be derived that the pH value of the product being measured is also 7. If the product being measured has more or less positive charges than the inner buffer 271, a potential difference of corresponding polarity will result.

The voltage potential that occurs at the lead-off element 281 is compared to the voltage potential occurring at the reference lead-off element 282, which independent from the ion concentration in the product being measured is ideally constant. The difference between the two voltage potentials forms the actual measurement signal, which provides information about the ion concentration in the product being measured.

The reference lead-off element is dipped into an electrolyte, normally a KCl solution 272, and is ionically conductive connected to it. The KCl solution 272, enclosed in a second chamber 292 between the outer wall of the inner tube 21 and the inner wall of the outer tube 22 diffuses slowly through a porous partition or diaphragm 26 into the product being measured and thereby establishes the electrical connection with it. It is important that the diaphragm 26 is liquid-permeable for the KCl solution 272, but that on the other hand no product being measured from outside should penetrate the KCl solution 272. This can be prevented, for instance by keeping the surface-level of the KCl solution 272 always higher than the surface-level of the product being measured. Moreover, the diffusion from the KCl solution 272 to the outside should be as big as possible, so that a low electrical internal resistance is assured. The diaphragm 26 is therefore a porous divider between the KCl solution 272 and the product being measured, which normally differ in ion-concentrations from each other. On the one hand, the diaphragm 26 prevents the solutions from being able to become equalized; however, on the other hand, an ion stream flows through it.

The glass membrane 25 comprises a special glass, for instance of 0.3 to 0.5 mm in thickness, which for reasons of mechanical stability are preferably blown into a hemisphere. Its composition is for example 72% SiO₂, 22% Na₂O, and 6% CaO, which can be produced by melting together appropriate quantities of SiO₂, Na₂CO₃, and CaCO₃.

Ideally, for producing the glass body of the pH electrodes, a dip tube 2 is used, which as shown in FIG. 6a has an outer tube 22 whose inner wall is connected by means of a plate 23 to an inner tube 21 in such a manner that a first chamber 291 (see FIG. 7), to be closed off on one end by the glass membrane 25, and a second chamber 292 (see FIG. 7), closed off on one end by the plate 23, are formed.

For forming the glass membrane 25, the dip tube 2 is guided into a crucible, and a small quantity of molten glass or a so-called gob 24 is withdrawn, which as shown in FIG. 6b, is connected to the lower edge of the outer tube 22. By supply of a gaseous medium, the gob 24 can be blown into a thin-walled, hemispherical glass membrane 25, thereby creating the glass body 20 shown in FIG. 6c.

The repeated withdrawal of glass from the crucible causes the level of the molten glass contained in it to change. As long as each processed dip tube 2 is always dipped to precisely the same depth into the crucible, the quantity of glass withdrawn, or the size of the gob 24 that is shaped into the glass membrane 25, therefore changes, resulting in pH electrodes with different measurement properties.

It has therefore been proposed in reference [5], German Patent Disclosure DE 101 16 099 A1, that reaching the surface of the molten glass during the lowering of the dip tube is detected, and the free end of the dip tube then is dipped into the molten glass to a fixed dipping depth, so that in each case a gob of a defined size is withdrawn.

From reference [6], German Patent DE 101 16 075 C1, it is known to measure the level of the molten glass and to control the positioning unit used to displace the dip tube in such a way that the free end of each dip tube is dipped into the molten glass at a fixed dipping depth.

In the methods and apparatus known from references [5] and [6], relatively complicated measuring instruments are used, which have to be adjusted correctly and checked regularly. The advantages of these kinds of apparatus therefore come only fully into play, subject to the findings described below, in fully automatic operation.

In the methods and apparatus known from references [5] and [6], however, still other problems can arise, which can involve high costs, particularly in fully automatic operation. Because of the thermal and mechanical actions during processing as well as in the insertion and removal of the dip tube, parts of it can be blasted off, which can lead to defective products on the one hand and a contamination of the molten glass on the other. Unless this is detected in good time, or averted, major additional expense can be borne. Sometimes, additional defective glass bodies are produced, because of the contaminated molten glass. If the problem is detected, the molten glass has to be replaced, which entails higher costs and an interruption in operation.

### SUMMARY

An improved method and an improved apparatus are disclosed for producing glass bodies.

In particular, an economically constructed apparatus is disclosed that is easy to handle, which can be used to create glass bodies of high quality. In addition, method steps and apparatus elements corresponding to them are to be disclosed with which the fabrication of glass membranes and their connection to a dip tube can be done with increased precision and quality.

The method according to the invention permits precise production of the glass bodies without requiring that the level of the molten glass has to be measured or detected continuously.

Moreover, method steps and apparatus elements corresponding to them are to be disclosed with which process mistakes and product defects in the production of the glass bodies are detected and/or avoided.

The method and apparatus according to the invention serve to produce a glass body, in particular a glass body provided with a glass membrane for a chemical sensor; a displaceably mounted dip tube through which a gaseous medium can flow is dipped into a mass of molten glass and pulled out again in order to withdraw a gob, which is then put into the desired shape by supply of the gaseous medium.

The dip tube is inserted reproducibly, in terms of the position of its lower end, into a mount which is connected to a displaceably supported carriage. The carriage is then displaced as far as a lower end position, and as the carriage moves downward the dip tube is dipped into the glass and upon retraction of the carriage, it withdraws a gob. The lower end position can be defined, for the dipping of at least one subsequent dip tube, by means of adjustment device and/or control device on the basis of the previously ascertained suitability of the gob for processing.

The adjustment device, being constructed in one or more parts, is readjusted by a certain amount manually or automatically after one or more withdrawals of a gob, in order to compensate for a change in the level of the molten glass that has been caused by the withdrawals of gobs.

The level of the molten glass is therefore not measured with the present apparatus; instead, with the first dip tube, an optimal withdrawal of a gob is sought. It is advantageous that at the very beginning of the working process, an optimal setting of the apparatus is already found, so that often already the first dip tube, and practically without exception at least the second dip tube, can be processed into an optimal glass body.

It is known from cumulative experience how the level of the molten glass changes after one or more withdrawals of a gob. Once the apparatus has been optimally adjusted on the basis of the first dip tube, the adjustment device is therefore readjusted manually or automatically by a certain amount after one or more withdrawals of a gob, so that the size of the sequentially withdrawn gobs remains constant.

Measurement errors, which can possibly be caused by external factors, and resultant changes in the quality of the finished glass bodies can be therefore avoided. Moreover, the cost for procurement and calibration of the measurement instruments can be averted.

The adjustment device can include a lower limiting element that is stationary or can be fixed in stationary fashion at a selectable end position, and a distance adjustment device, which is connected to the lower limiting element or the carriage and by means of which the spacing between the lower limiting element and the carriage, moved toward the lower limiting element, and thus the lower end position of the carriage can be adjusted. When the apparatus is started up, the adjustment device is adjusted such that in each case, the carriage is stopped before the end of the dip tube to be processed dips into the molten glass. The missing distance can then be precisely readjusted by means of the finely adjustable distance adjustment device.

In addition, an upper limiting element which is stationary or can be fixed to be stationary is provided, toward which the carriage is pulled into an upper end position by means of a tension element, such as a weight or a spring, and held stably, in which position the dip tube to be processed can be inserted and the finished glass body can be withdrawn. The carriage is therefore displaceable between the lower and upper end positions, for instance along a guide rail.

In a further embodiment, a reference element that can be extended and retracted is provided, which after being extended indicates the set-point position of the inserted dip tube, preferably the set-point height of the part of the dip tube to be dipped into the molten glass, so that the dip tube can be positioned appropriately. This prevents dip tubes, which may have dimensions differing from one another, from being differently positioned inside the mount and as a result dipped to various depths into the molten glass. Naturally, this version can also be used advantageously whenever the level of the molten glass is measured and the mount is displaced in accordance with the measurement results on hand.

In a further preferred embodiment, a heater, such as a burner, that can be extended and retracted is provided, which is guided toward the part of the dip tube to be dipped into the molten glass, and which heats the dip tube for a determinable or predetermined length of time. On the basis of the end positioning of the dip tube by means of the reference element, the part of the dip tube to be processed is always heated precisely. Heating the part of the dip tube to be dipped into the molten glass makes a more problem-free pickup of the gob possible. On the one hand, possible breakage of glass and hence contamination of the molten glass are largely avoided. On the other, a better connection of the picked up gob with the dip tube results.

In a further advantageous feature, a drive unit is provided, which can be connected to the mount by means of a drive shaft oriented coaxially to the longitudinal axis of an inserted dip tube and is controllable such that the mount is rotatable in the upper end position, during the heating of the dip tube, or after the withdrawal and/or during the shaping of the gob. As a result, uniform processing of the dip tube and uniform distribution of the gob are accomplished.

The supply of the gaseous medium can be effected through an internal conduit, provided with inlet and outlet openings, into the drive shaft, which is connected by means of sealing elements with the dip tube and a pressure cylinder, by which the gaseous medium can be supplied to the inlet opening or openings.

The pressure of the gaseous medium supplied to the dip tube by a pump device can advantageously be checked during the shaping of a gob, so that if a pressure drop caused by breakage of glass occurs, a control signal can be output, by means of which a defect can be recorded. As a result, any further processing of glass bodies that are defective can be prevented, and splinters of glass can be prevented from dropping undetected into the molten glass and contaminating it.

In a further advantageous feature, an extensible and retractable cover element is provided, which is guided to a location above the molten glass and is retracted again when the carriage is guided toward the end position, or new raw material is introduced into the crucible. The control of the cover element can be done as a function of output signals of at least one sensor that monitors of the carriage. The sensor is positioned for instance in the vicinity of the upper end position.

An exemplary apparatus according to the invention can be realized with a low or a high degree of automation. Manually operable switches are for instance provided, with which the drive unit and/or drive devices with which the reference element, heater and optionally the cover element can be extended and retracted can be controlled.

The course of the method can, however, also be controlled by a program which detects changes in the status of the apparatus that are reported to the control unit by means of manually or automatically actuated switches or by sensors.

### BRIEF DESCRIPTION OF THE DRAWINGS

Exemplary embodiments are described in further detail below in conjunction with drawings. Shown are:

FIG. 1, an exemplary apparatus 1 while it is being started up;

FIG. 2, an exemplary detail of the apparatus 1 of FIG. 1 in the end positioning of a dip tube 2 in a mount 63, connected to a carriage 80, on the basis of a reference element 42;

FIG. 3, a detail of the apparatus 1 of FIG. 1 after a drive unit 61, provided for rotating the mount 63, is switched on and after a heater 52 is actuated;

FIG. 4, the apparatus 1 of FIG. 1 with the carriage 80 having been moved downward, whose end position is calibrated, by means of a distance adjustment device 27 braced on a lower limiting element 13, such that the dip tube 2 dips to the requisite extent into a mass of molten glass 4;

FIG. 5, the apparatus 1 of FIG. 1 with the carriage 80 moved upward, during the shaping of a gob 24 withdrawn from the molten glass 4;

FIG. 6a, a dip tube 2 before the withdrawal of a gob 24;

FIG. 6b, the dip tube 2 of FIG. 6a after the withdrawal of a gob 24;

FIG. 6c, the dip tube 2 of FIG. 6b, with a glass membrane 25 completed by shaping of the gob 24;

FIG. 7, a known pH electrode; and

FIG. 8, a fully automated apparatus 1 with a motorized carriage 80 and with a camera 120.

### DETAILED DESCRIPTION

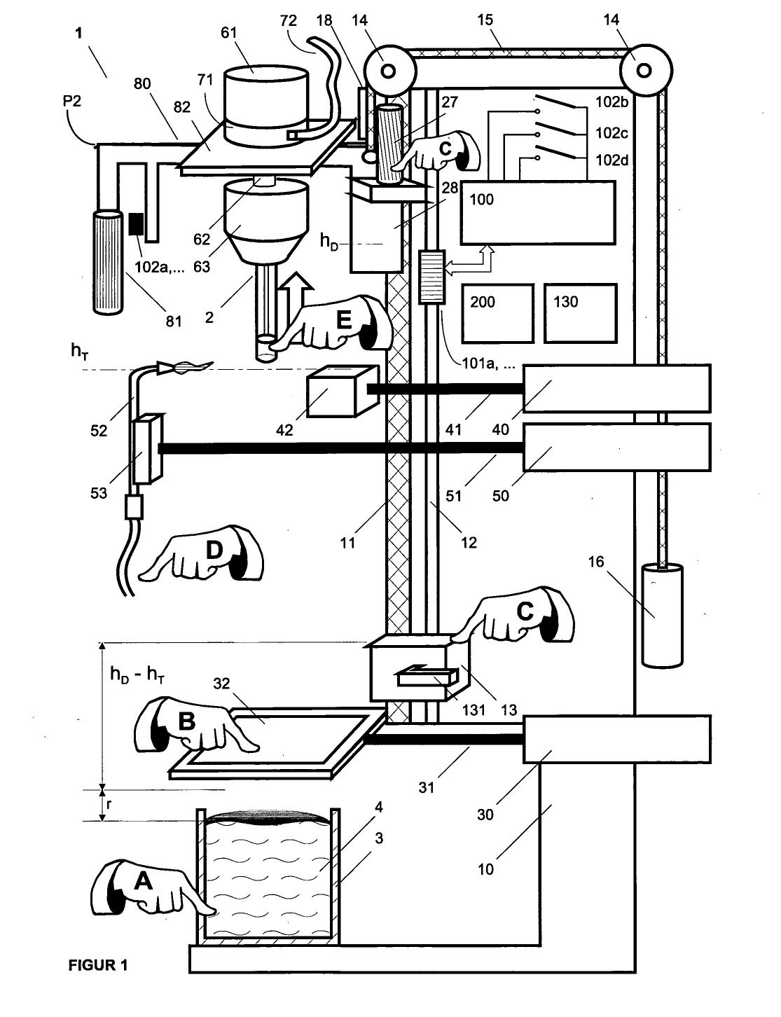

An exemplary apparatus and an exemplary method will be explained in conjunction with FIGS. 1-5. The method steps are marked with letters A through T and are symbolically represented by a drawing of a hand.

FIG. 1 shows an apparatus 1 in an advantageous embodiment with a mounting stand 10, which is provided with a guide rail 11, along which a carriage 80 is supported displaceably between a lower and an upper limiting element 13; 18, by means of which elements a lower and an upper end position P1 and P2 (see FIG. 1 and FIG. 4), respectively, for the carriage 80 are defined. In FIG. 1, the carriage 80 is shown in the upper end position P2. In this end position P2, it is held by means of a freely suspended weight 16, which is connected to the carriage 80 by a cable 15 guided over deflection rollers 14. The weight 16 is selected such that the carriage 80 is held stably in the upper end position P2 and with only a slight expenditure of force can be pulled into the lower end position P1, in which the dip tube 2 can dip into a mass of molten glass 4 provided in a crucible 3.

The carriage 80, which can be grasped at a handle 81, is provided with a mounting plate 82, on which a drive unit 61 is disposed that is connected by means of a vertically oriented drive shaft 62 to a mount 63, which is provided below the mount 82 and into which a dip tube 2 is inserted coaxially to the drive shaft 62.

The supply of the gaseous medium is effected through a hose 72, which optionally is connected to a pump device 130 or is operated by a user and which is connected to a sealed transfer cylinder 71, inside which the drive shaft 62, provided with an internal conduit, is disposed rotatably in such a way that a tightly sealed chamber is formed, inside which the gaseous medium can be introduced through at least one inlet opening into the internal conduit. Through the internal conduit of the drive shaft 62 and the mount 63 optionally provided with a sealing element, the gaseous medium can be introduced into the inserted dip tube 2.

Moreover, the carriage 80 is provided with a distance adjustment device 27, by means of which a piston 28, oriented toward the lower limiting element 13, can be displaced vertically. The lower limiting element 13 is supported displaceably in a guide groove 12 and can be fixed in a selected end position with a lever 131.

Also shown in FIG. 1 are three drive mechanisms 30, 40, 50, which have cylinders with pistons 31, 41, 51 that can be extended and retracted.

The piston 31 of the lowermost drive mechanism 30 is connected to a cover element 32 which is, for example, guided to a location above the molten glass 4 and is retracted again as a function of signals output by sensors 101a, 101b, . . . , whenever the carriage 80 is guided toward the lower end position P1. The molten glass 4 therefore continues to be protected against falling foreign substances, such as parts of the inserted dip tube 2 or glass body 20 that can break off in the course of the manipulations to be done. Because of the stringent demands in terms of the quality of the material composition of the molten glass 4 that are required for manufacturing the glass membranes 25, the molten glass 4 would otherwise have to be replaced, which in relative terms is quite costly in both time and material.

The piston 41 of the topmost drive mechanism 40 supports a reference element 42, which after it has been extended indicates the set-point position of an inserted dip tube 2. An important factor here is the location of the part of the dip tube 2 to be processed, which should be brought exactly to the end position indicated by the reference element 42. That is, once the apparatus 1 has been adjusted, only the changes in the level of the molten glass 4 and changes in the location and size of the dip tube 2 need to be taken into account. If an inserted dip tube 2 inside the mount 3 is pressed against a fixed stop, then the location of the fastened part of the dip tube 2 is always the same. However, the dip tubes 2 have relatively high variations in production, so that even if the dip tube 2 is correctly in positioned in the mount 63, its end piece to be processed may deviate from the set-point position. This problem can be overcome by using the reference element 42.

Preferably the piece, to be processed, of the dip tube 2 is heated uniformly before being dipped into the molten glass 4, to assure that the gob 24 can be picked up without problems and to prevent possible breakage of the dip tube 2 from high temperature changes while it is being dipped into the molten glass 4. To that end, the piston 51 of the further drive mechanism 50 is connected by means of a mounting element 53 to a burner 52, whose flame is located at the height of the reference element 42, that is, the height of the set-point position of the part to be processed of an inserted dip tube 2. By means of the associated drive mechanism 50, the burner 52 can therefore be moved toward the part to be processed of the inserted dip tube 2, in order to heat it.

In order to heat the part to be processed of the inserted dip tube 2 uniformly, the drive unit 61 is started up by means of a switch 102a, which for the sake of easy handling is located near the handle 81. Once the drive unit 61 has been started, the dip tube 2 rotates about its longitudinal axis, thereby being heated uniformly.

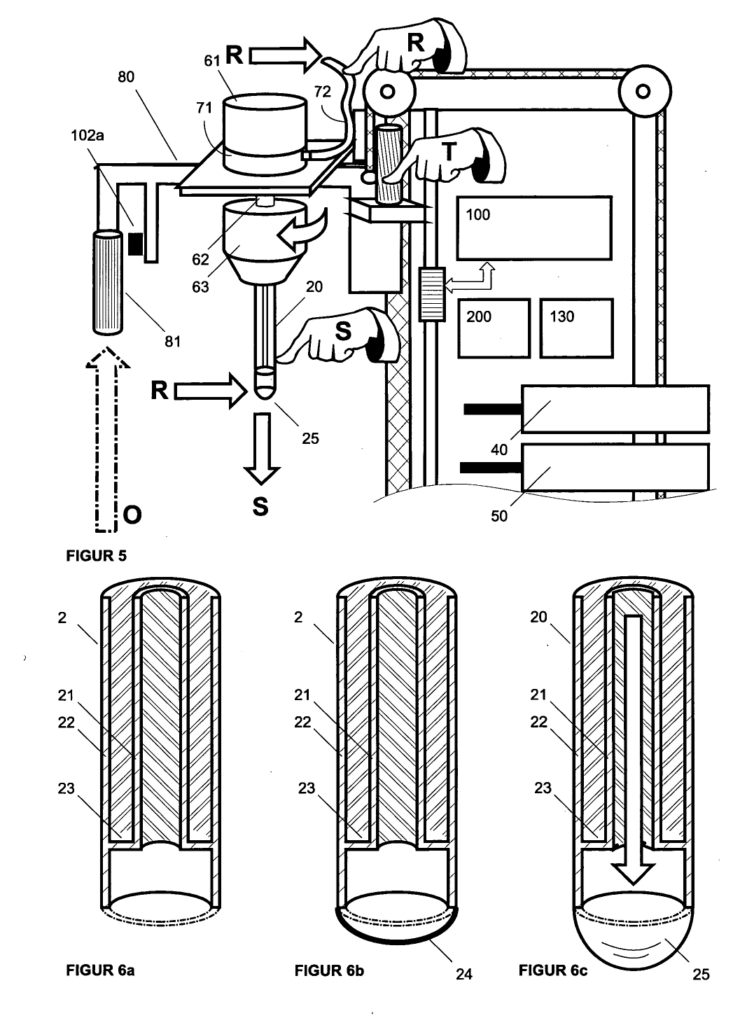

The drive unit 61 can also be started after the withdrawal and/or during the processing of a gob 24, so that the mass of the gob is distributed uniformly and forms an optimally shaped glass membrane 25 (see FIGS. 6a-6c).

In FIG. 1, switches 102b, 102c, 102d, . . . , which can be actuated manually or automatically, upon the motion of apparatus parts, and sensors 101a, 101b, 101c, . . . are shown symbolically. By means of these switches 102b, 102c, 102d and sensors 101a, 101b, 101c, . . . , the production process can be controlled. The switch 102b serves for instance to activate the drive mechanism 30 and is actuated automatically by the moving carriage 80. The switches 102c and 102d serve to activate the drive mechanisms 40, 50 and can be actuated by hand or by means of foot pressure. A power supply unit 200 is also shown symbolically.

The process of starting up the apparatus 1 will be described below in conjunction with FIG. 1 and in terms of method steps A through E. The other method steps F through T will be described in conjunction with FIGS. 2-5.

First, glass is melted in the crucible 3 (step A). Next, the cover element 32 is moved to a location above the molten glass 4, so that in the later manipulations no foreign bodies can fall into the molten glass 4 (step B).

If it is not already correctly positioned, then the lower limiting element 13 and the distance adjustment device 27 are adjusted such that the carriage 80 can be moved into the lower end position P1, without an inserted dip tube 2 dipping into the molten glass 4 (step C). The spacing between the original height h_{D} of the stop, formed by the distance adjustment device 27, and the height h_{T} of the reference element 42 should therefore be, for example, approximately equal to the distance between the stop of the lower limiting element 13 and the upper edge of the crucible 3, so that a residual distance r from the level of the molten glass 4 is left. As shown in FIG. 4, this residual distance r can be overcome by calibration of the distance adjustment device 27 in a later method step (see FIG. 4, step N).

With the optional step D, the burner 52 is switched on, after which the preparations for the calibration steps are finished by insertion of a dip tube 2 into the mount 63, for instance a multiple-jaw chuck (step E).

As shown in FIG. 2, the reference element 42 is then extended (step F); the dip tube 2 is positioned at its set-point height h_{T} (step G); and the reference element 42 is retracted (step H).

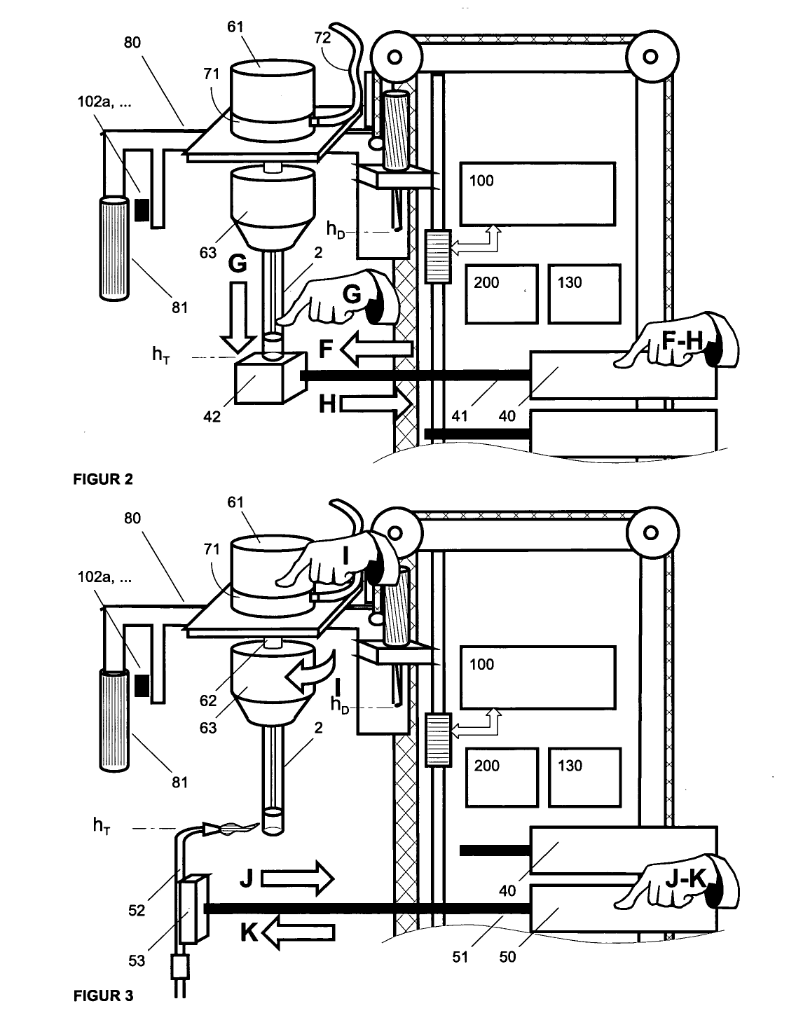

FIG. 3 shows further optional method steps. With step I, the drive unit 61 is started up, which rotates the mount 63, with the dip tube 2 inserted, about the longitudinal axis of the dip tube. Next, with step J, the burner 52 is moved toward the dip tube 2 at the height h_{T}, so that the part of the dip tube 2 to be dipped into the molten glass 4 is heated uniformly, after which the burner 52 is retracted again (step K).

As shown in FIG. 4, the carriage 80 is then grasped by the handle 81 and moved into the lower end position P1, that is, far enough that the distance adjustment device 27 meets the lower limiting element 13 (step L). Before the lower end position P1 is reached, the displacement of the carriage 80 is detected by the sensor 101a, so that by automatic actuation of the switch 102b, the cover element 32 is retracted (step M).

By calibration of the distance adjustment device 27, the carriage 80 with the dip tube 2 is then lowered far enough that a suitable gob 24 can be withdrawn from the molten glass 4 (step N). In the calibration of the apparatus 1 or in later operation as well, the dip tube 2 can also be lowered into the molten glass 4 repeatedly.

After a gob 24 has been withdrawn, the carriage 80 is raised again (step O), and the drive unit 61 is started again (step P), so that the mass of the gob 24 is distributed uniformly by means of rotation. After the withdrawal of the gob 24, the cover element 32 is extended again to protect the molten glass 4.

During the calibration operation, the gob is assessed by the operator as to its suitability for processing, and in the event of an unsatisfactory outcome, the distance adjustment device 27 is readjusted somewhat. Such an assessment can also be made after the step S discussed below, in which the finished membrane is monitored. If the gob is found suitable, then as a rule, for the entire further production process of the glass bodies, no further assessment step is performed.

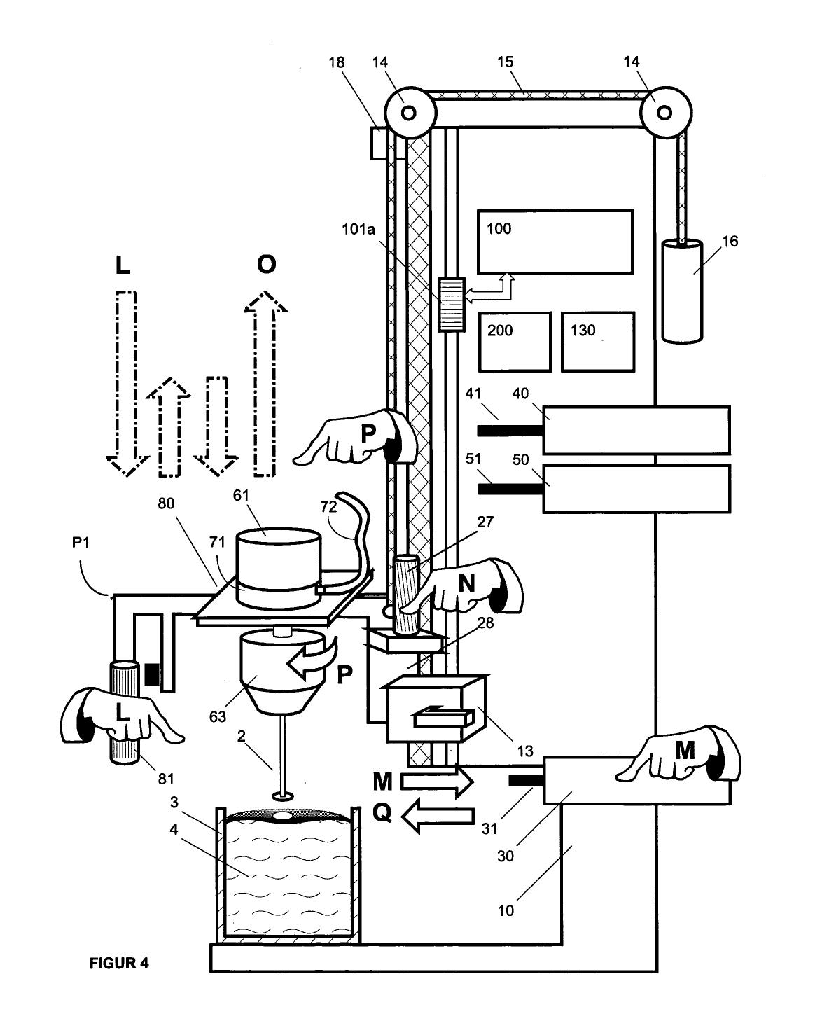

FIG. 5 shows the shaping of the glass membrane 25 by supply of the gaseous medium. For instance, air is blown into the hose 72, or the hose is connected to the pump device 130 (step R). By monitoring the pressure, any glass breakage that might have occurred can be detected. Next, the completed glass body 20 is withdrawn (step S).

Next, after one or more withdrawals of a gob 24, the distance adjustment device 27 is readjusted manually or automatically by a certain amount (step T), in order to compensate for a change in the level of the molten glass 4 that has been caused by the withdrawal of gobs 24.

In pH electrodes, the internal resistance of the voltage source is extremely high, which is why complicated electronic measurement and amplifier circuits are required, if it is to be at all possible for the voltage signal to be displayed. The electrical internal resistance of the measurement electrode is approximately 10⁹ ohms, dictated by the glass membrane 25. It has been found that by means of a suitable design, with as thin walls as possible, of the glass membrane 25, the internal resistance of the measurement electrode can be reduced markedly, to make more-precise measurements as well as simpler measurement circuits. An important factor of an exemplary embodiment is that the glass membrane 25 have the most uniform possible, low thickness. This is achieved, for example, by rotating the dip tube 2, after withdrawal of the gob 24, in such a way that its axis is no longer oriented vertically. The dip tube 2 can be pivoted upward by approximately 135° and then, during axial rotation, processed by means of supply of the gaseous medium. Because of the centrifugal forces caused by the axial rotation of the glass tube 2 and the force of gravity acting on the gob 24, the lumplike mass of the gob can flow uniformly to the edges of the dip tube 2, as a result of which a uniformly thin wall is created in the central part of the glass membrane 25. It is understood that this method can also be used in other apparatuses, such as those described in references [5] and [6].

The rotation of the dip tube 2 out of its vertical orientation can be accomplished by simple means. For instance, the mounting plate 82 is connected to the carriage 80 by means of a joint, so that after the gob 24 is withdrawn the mounting plate 82 can be rotated or folded over by the requisite amount. This can be accomplished by, for example, pneumatic means or by a further drive motor, disposed on the carriage 80. It is also possible to use, for example, a robot arm, which can hold the dip tube 2 and put it into the requisite positions by rotating and displacing it.

FIGS. 6a-6c show the dip tube 2 before a gob 24 is withdrawn, after a gob 24 is withdrawn, and after the fabrication of the glass membrane 25, respectively.

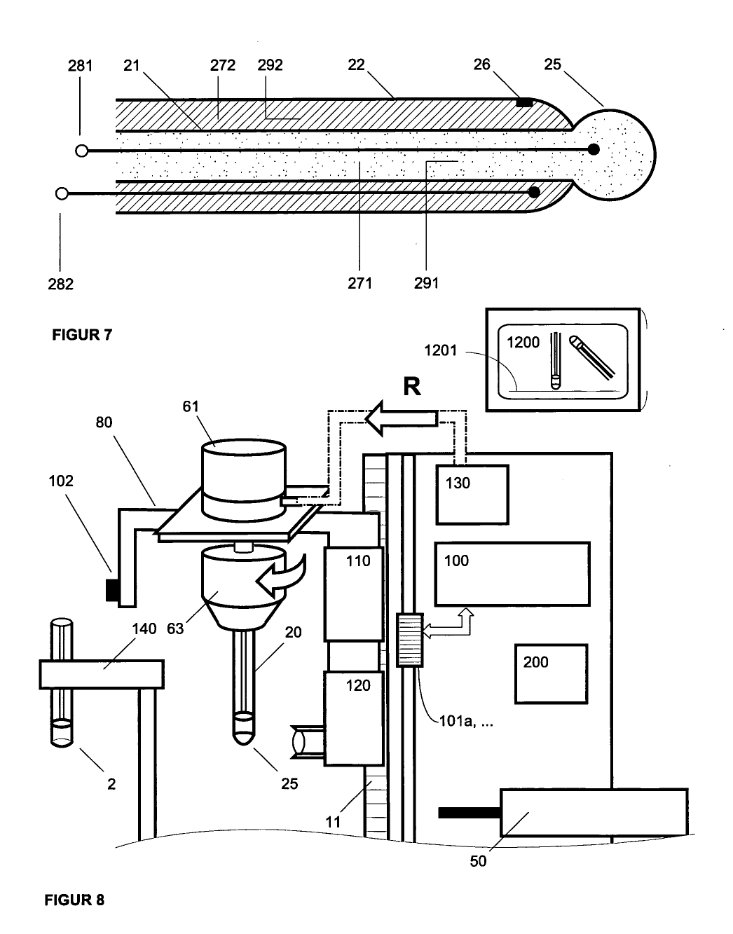

FIG. 7 shows the pH electrode described at the outset.

An exemplary apparatus 1 and method have been described and shown. However, still other embodiments can be attained within the competence of one skilled in the art. For example, the order of individual method steps can be reversed. Moreover, the degree of automation of the apparatus can be selected as needed.

FIG. 8 shows a fully automated apparatus 1 with a carriage 80, which has a drive motor 110, such as a stepping motor, and a camera 120. The drive motor 110, which may also be connected to the carriage 80 by drive means, chains or cables, for instance drives a gear wheel which meshes with the guide rail 11 that is provided with toothing.

The carriage 80 can therefore be put, under the control of the control unit 100, from the upper end position P2 to the lower end position P1 (see FIGS. 1 and 4) without using mechanical adjustment devices. The upper end position P2 can be defined for instance by an optical sensor 101b. The lower end position P1 can be defined by predetermination of the number of rotations of the drive shaft or predetermination of the number of steps of the drive motor 110. By incrementing the number of rotations of the drive shaft or number of steps of the drive motor 110, the lower end position P1 can be adapted to changes in the level of the molten glass 4.

By means of the camera 120, the deformation of the glass membrane 25 can be photographed and compared with set-point values, so that the shaping of the glass membrane 25 can be performed automatically. The dip tube 2 can be, as described in references [5] and [6], acted upon by a blowing pressure which follows a blowing pressure curve that is defined in a computer provided in the control unit 100.

The glass tubes 2 can be delivered and lead away by means of a robot arm 140 connected to the control unit 100; this robot arm is also suitable for vertically positioning the glass tubes 2 introduced or inserted into the mount. The vertical positioning can be done automatically by means of the image data taken by the camera 120, so that the use of a reference element 42 can be dispensed with. Reference data can also be provided in the robot arm 140, so that it positions the dip tubes 2 correctly in each case. For manual positioning of the dip tubes 2, the pictures taken by the camera 120 can also be displayed, provided with a reference line 1201, on a picture output unit 1200, such as a flat screen. In that case, the user can displace an inserted dip tube 2 vertically in such a way that its lower edge matches the reference line 1201. Moreover, the precise positioning of the lower edge of the dip tubes 2 by means of the camera 120 can result in an always precisely identical photograph of the glass membranes 25 to be shaped, as a result of which a simpler and more-precise comparison can be made with the set-point data.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A method for producing a glass body provided with a glass membrane for a chemical sensor, comprising:
inserting a dip tube reproducibly, with respect to a position of its lower end, into a mount joined to a displaceably supported carriage;
displacing the carriage as far as a lower end position (P1); and
dipping the dip tube into a mass of molten glass as the carriage is moved downward and upon retraction of the carriage pulling the dip tube out of the molten glass to withdraw a gob that can be placed into a desired shape by supply of a gaseous medium, the lower end position being defined, for dipping at least one subsequent dip tube, by means of an adjustment device and/or a control device based on a previously ascertained suitability of the gob for processing.

2. The method of claim 1, wherein after at least one withdrawal of a gob, the lower end position (P1) is readjusted manually or automatically by a certain amount by means of the adjustment device and/or the control device, to compensate for a change in level of the molten glass that has been caused by the withdrawal of gobs.

3. The method of claim 1, wherein the carriage is fixed in an upper end position (P2), in which the dip tube to be processed is inserted and a completed glass body is withdrawn, and wherein for positioning the dip tube:
a) either a reference element, which indicates a desired position of a portion of the dip tube to be dipped into the molten glass, is extended; or
b) the dip tube, optionally introduced into the mount by means of a robot arm, is photographed by means of a camera, and corresponding image data
b1) and reference data are displayed on an image output unit; or
b2) are compared in the control device with set-point values to position the dip tube correctly by means of the robot arm.

4. The method of claim 1, wherein after a positioning of the dip tube, a heater is guided toward a portion of the dip tube to be dipped in the molten glass, which heats the dip tube for a determinable or predetermined length of time.

5. The method of claim 4, wherein the mount is rotated during the heating of the dip tube in an upper end position (P2), or after the withdrawal and/or during shaping of the gob.

6. The method of claim 1, wherein an extensible and retractable cover element is provided, which is guided to a location above the molten glass and is retracted again, using signals output by sensors, whenever the carriage is guided to the lower end position (P1).

7. The method of one of claim 1, wherein supply of the gaseous medium is controlled by the control device as a function of a blowing pressure curve and/or as a function of image data, acquired by means of a camera, that are compared with set-point data.

8. The method of claim 1, wherein a pressure of the gaseous medium is monitored during shaping of the gob, and when a pressure drop occurs, a control signal is output by means of which an error is recorded.

9. The method of claim 1, wherein after withdrawal of a gob, the dip tube is rotated out of a vertical position, by approximately 135°.

10. An apparatus for producing a glass body provided with a glass membrane for a chemical sensor, comprising:
a mount provided on a displaceably supported carriage, by means of which mount a dip tube through which a gaseous medium can flow can be dipped into a mass of molten glass and retracted again to withdraw a gob which is subsequently put into a desired shape by supply of the gaseous medium;
means for reproducibly positioning the dip tube in the mount with respect to its lower end and for monitoring the positioning; and
an adjustment device and/or a control device, by means of which a lower end position (P1) for the carriage can be adjusted, in which position the dip tube, when the carriage is moved downward, dips into the molten glass and upon retraction of the carriage withdraws a gob suitable for processing.

11. The apparatus of claim 10, wherein the adjustment device includes a lower limiting element, which is stationary or can be fixed in stationary fashion in a selectable end position, and a distance adjustment device, joined to the lower limiting element or to the carriage, by means of which spacing between the lower limiting element and the carriage moved toward the lower limiting element, and thus the lower end position (P1), are adjustable.

12. The apparatus of claim 10, wherein after at least one withdrawal of a gob, the lower end position (P1) is readjusted by a certain amount,
a) manually by means of actuation of the adjustment device; or
b) automatically by means of the control device, by control of the adjustment device or of a drive motor connected to the carriage, to compensate for a change in level of the molten glass that has been caused by withdrawal of gobs.

13. The apparatus of claim 10, comprising:
a) an upper limiting element that is stationary or can be fixed in stationary fashion, toward which the carriage is pulled by means of a tension element, into an upper end position (P2) and held stably, in which position the dip tube to be processed can be inserted and a completed glass body can be withdrawn, or
b) an upper end position (P2) defined by means of at least one position sensor and the control device, by which the carriage provided with the drive motor is displaceable between the upper and lower end positions (P1, P2).

14. The apparatus of claim 10, comprising:
a) an extensible and retractable reference element, which after being extended indicates a set-point position of a part of the dip tube to be dipped into the molten glass, so that this tube or part is suitably positionable; or
b) the dip tube, optionally introduced into the mount by means of a robot arm, photographed by means of a camera, and
b1) corresponding image data and a reference datum are displayed on an image output unit to position the dip tube manually; or
b2) corresponding image data are compared in the control device with set-point values to position the dip tube correctly by means of the robot arm.

15. The apparatus of claim 10, comprising:
a heater that can be extended and retracted, and which, optionally controlled by the control unit, can be guided toward a part of the dip tube to be dipped into the molten glass and which heats this part for a determinable or predetermined length of time.

16. The apparatus of claim 15, comprising:
a drive unit, which by means of a drive shaft oriented coaxially with a longitudinal axis of an inserted dip tube, is joined to the mount and can be controlled such that the mount is rotatable in an upper end position (P2) during heating of the dip tube, or after the withdrawal and/or during shaping of the gob.

17. The apparatus of claim 16, wherein the drive shaft is provided with an internal conduit and openings, through which the gaseous medium can be introduced into the dip tube.

18. The apparatus of claim 17, wherein supply of the gaseous medium can be controlled by the control device as a function of a blowing pressure curve and/or as a function of image data, taken by means of a camera, which are compared with set-point data.

19. The apparatus of claim 18, wherein the pressure of a gaseous medium supplied by a pump device can be monitored during shaping of the gob, and when a pressure drop occurs a control signal can be output by means of which an error can be recorded.

20. The apparatus of claim 10, comprising:
an extensible and retractable cover element, which is guided to a location above the molten glass and is retracted again as a function of signals output by sensors, whenever the carriage is guided to the lower end position (P1).

21. The apparatus of claim 10, comprising:
sensors and/or switches with which a drive unit, a drive motor connected to the carriage, and/or drive units can be controlled, with which units and/or motor a reference element, a heater and/or cover element for the molten glass can be extended and retracted.
